(19) United States
(12) Patent Application Publication
(10) Pub. No.: US 2009/0028731 A1
(43) Pub. Date: Jan. 29, 2009

(54) Ball bearing and a vacuum pump that is equipped with a bearing of this type

(75) Inventors: Heinrich Englander, Linnich (DE); Karl-Heinz Volker, Titz (DE); Wolfgang Schulz, Beeton (CA)

Correspondence Address: FAY SHARPE LLP, 1100 SUPERIOR AVENUE, SEVENTH FLOOR, CLEVELAND, OH, 44114, US

(73) Assignee: LEYBOLD VAKUUM GmbH, Koln (DE)

(21) Appl. No.: 12/228,903

(22) Filed: Aug. 18, 2008

Related U.S. Application Data
(62) Division of application No. 10/536,473, filed on May 25, 2005, now abandoned.

(30) Foreign Application Priority Data
Nov. 19, 2002 (DE) 102 56 086.2
Oct. 24, 2003 (EP) PCT/EP03/01770

(51) Int. Cl. F04D 29/046; F16C 33/00; F16C 21/00

(52) U.S. Cl. 417/423.12; 384/625; 384/126

(57) ABSTRACT

A ball bearing (1) has an inner race (2) and an outer race (3). In order to prevent the rotating parts from being damaged when the bearing assembly fails, the bearing has emergency bearing surfaces (14, 15) which are concentric to the rotational axis (6) and of which one is a part of the rotating bearing race and the other is a part of the fixed bearing race. During normal operation, the emergency bearing surfaces (14, 15) are situated opposite one another with a relatively narrow gap (24) therebetween. But, in the event of failure, the surfaces (14, 15) engage and function as emergency bearing surfaces.

This application is a divisional of U.S. application Ser. No. 10/536,473, filed May 25, 2005.

### BACKGROUND OF THE INVENTION

The present invention relates to a ball bearing having an inner race and an outer race. Moreover, the present invention relates to a vacuum pump, preferably a turbomolecular vacuum pump equipped with a ball bearing of this type.

Ball bearings of the type stated serve the purpose of holding and guiding rotatable machinery components, generally shafts. The outer race—in the instance of inverted bearings also the inner race—is supported by a fixed component (bearing disk, housing or alike). Generally bearings of this type are oil- or grease-lubricated bearings. The present invention may also be applied to grease-free bearings. Equally the present invention is independent of whether the bearings are implemented with or without a cage.

It is the task of the present invention to implement a ball bearing of the aforementioned kind such that in the event of a failure of the bearing and guidance of the rotating component damage to, respectively within the machine is avoided.

### SUMMARY OF THE INVENTION

This task is solved by the present invention through the characterising features and measures of the patent claims.

In that the gap between surfaces which oppose each other is relatively small, these surfaces assume in the instance of uncontrolled movements of the rotating unit the function of emergency bearing surfaces. The rotating unit is guided in a single emergency rundown to standstill without the occurrence of a rotor crash. The friction produced during an emergency rundown is so great that the installed drive power will no longer suffice. The converter of the drive unit switches to failure so that standstill is attained rapidly.

Still further advantages of the present invention will be appreciated to those of ordinary skill in the art upon reading and understanding the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIGS. 1 to 4 depict cross sections of ball bearings with differently designed emergency bearing surfaces and

FIG. 5 depicts a molecular drag vacuum pump equipped with emergency bearing surfaces in accordance with any one of FIGS. 1-4.

### DETAILED DESCRIPTION OF THE PREFERRED EMBODIMENTS

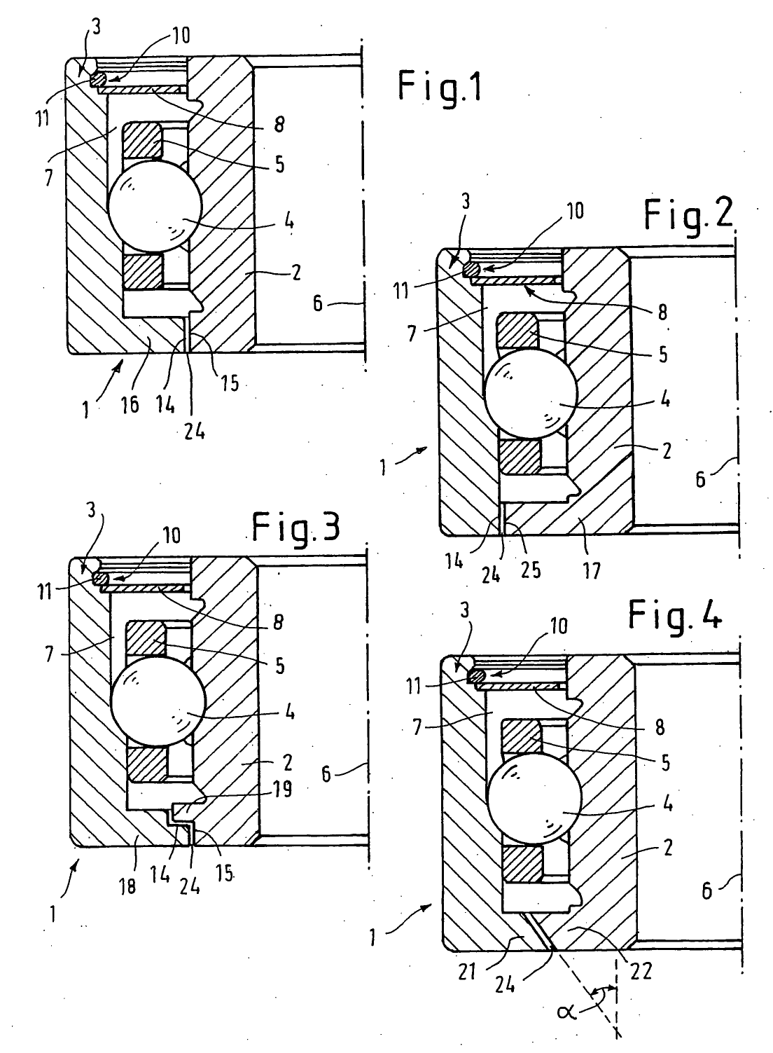

The bearings 1 depicted in the drawing FIGS. 1 to 4 exhibit each an inner bearing race 2, an outer bearing race 3, balls 4 and a cage 5. The axis of the bearing 1 is in each case designated as 6. In the axial direction (in the drawing FIGS. 1 to 4 at the top in each instance) the inner chamber 7 of the ball bearing 1 is substantially sealed by a bearing cover 8 and specifically employing a snap ring 10 which is clamped within an inner groove 11 in the outer bearing race 3. Commonly bearing covers of this type are provided to both sides of the balls 4.

In order to form the emergency bearing surfaces 14, 15 in accordance with the present invention one or both bearing races 2, 3 are equipped with ring-shaped projections which—when arranged on the side opposing the bearing cover 8 simultaneously provide the function of a second bearing cover 8. In the solution in accordance with FIG. 1 the outer bearing race 3 is provided on its side opposing the bearing cover 8 with a projection 16 extending in the direction of the inner race 2. The inner surface of said outer bearing race 3 forms with reference to the axis 6 the cylindrical emergency bearing surface 14. The section of the outer surface of the inner race 2 opposing said surface 14 is the second emergency bearing surface 15.

In the solution in accordance with FIG. 2, the inner race 2 is equipped with a projection 17 extending radially towards the outside. The outer surface of the inner race 2 and a part of the inner surface of outer race 3 also form cylindrical emergency bearing surfaces 14, 15.

In the solutions in accordance with FIGS. 3 and 4 the inner bearing race 2 and the outer bearing race 3 are equipped with projections 18, 19 respectively 21, 22. The emergency bearing surfaces 14, 15 opposing each other exhibit a stepped cross-section (FIG. 3) respectively form with the axis 6 the angle α. In this manner emergency bearing surfaces are created which not only become effective in the instance of a failure of the radial guidance of the rotating system by the bearings but also in the instance of an axial failure.

The size of the gap 24 between the emergency bearing surfaces 14, 15 should be as small as possible. However, the size of said the gap must not fall below the permissible bearing tolerances. The fact that the bearing tolerances are frequently different in the radial and the axial direction needs to be taken into account when selecting the gap size.

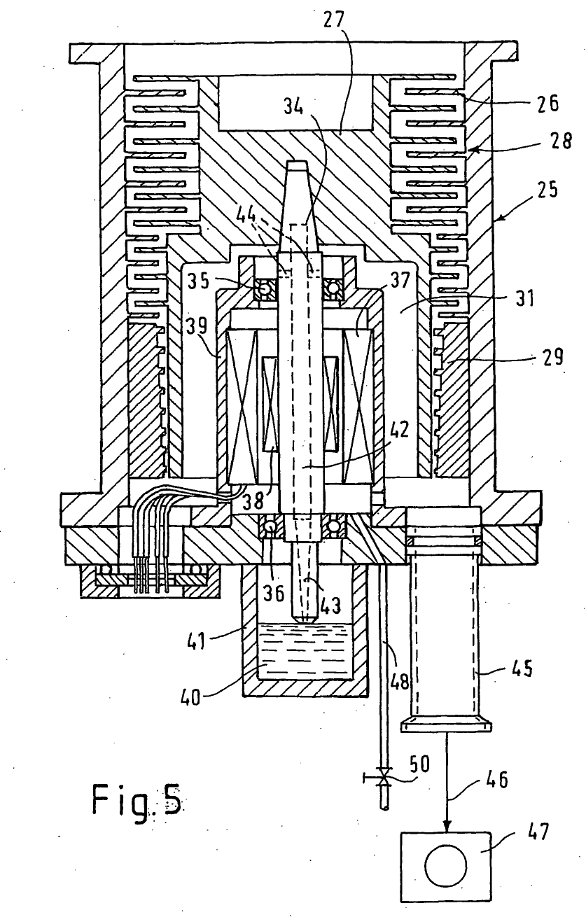

FIG. 5 depicts as an example for a molecular drag vacuum pump a turbomolecular pump 25 the stator of which is designated as 26 and the rotor of which is designated as 27. Said pump is designed by way of a compound pump and is equipped with a turbomolecular pumping stage 28 equipped with blades and a molecular pumping stage 29 equipped with a thread. The rotor 27 is partly of a bell-shaped design. Within, respectively slightly below the space 31 encompassed by the bell, the rotor is supported rotatably through the shaft 34 in the bearings 35 and 36. Moreover, there is accommodated within the space 31 the electric drive motor, its stator pack which is designated as 37 and the rotor pack which is designated as 38. The bearings 35, 36 and the rotor stator 37 are supported by a sleeve-like carrier 39.

For the purpose of supplying the bearings 35 and 36 with a lubricant, a vessel 41 filled with oil 40 is affixed underneath the turbomolecular pump 25. The drive shaft 34, the lower end of which is immersed in the oil exhibits an inner coaxial bore 42 which owing to the conically expanding bottom section 43 effects pumping of the lubricating oil towards the top. Through cross bores 44 the oil first arrives at the upper bearing 35 and there flows, due to the effect of gravity, through the bottom bearing 36 back into the oil vessel.

Through the forevacuum port 45 and the line 46 the turbomolecular pump 25 is connected to the forevacuum pumping facility 47. Since there exists between the motor/bearing chamber 31 and the forevacuum port 45 a connection, there also prevails in space 31 the necessary forevacuum pressure needed to operate the turbomolecular pump. In order to prevent corrosive gases being pumped by the turbomolecular pump from entering into the bearing chamber 31, a purge gas facility is provided which initially comprises the gas admission pipe 48 opening out into the bearing chamber. For the purpose of admitting the purge gas in a controlled manner said gas inlet pipe 48 exhibits a valve 50. The purge gas (N₂ for example) entering into the motor/bearing chamber 31 flows through the motor as well as the upper bearing 35 and passes outside the bearing carrier 39 to the discharge port 45. Thus the entry of corrosive gases, which are being pumped by the turbomolecular pump 25, into the motor/bearing chamber 31 is prevented.

Within the scope of the present invention one bearing or both bearings 35, 36 has/have been designed (not depicted in detail) as depicted in one of the FIGS. 1 to 4. An advantage of this measure is that in the instance of a failing bearing, the active pumping surfaces (blades of the rotor/stator thread) are not damaged. The gap 24 between the emergency bearing surfaces 14, 15 defines in the instance of a failed bearing the maximum deflection of the rotor 27 from its nominal position. Correspondingly narrow also the distances between the active pumping surfaces can be selected. The smaller these distances, the better the properties of the pump. Moreover, the fact, that between the bearing races 2, 3 at least for bearing 35 there exists a narrow relatively long gap 24, offers the advantage of a considerable reduction in the rate of the purge gas flowing through the bearing. Finally, the projections at the bearing races 2, 3 permit larger contact surfaces which effect an improvement in the dissipation of heat from the bearing.

The gap 24 needs to be selected corresponding to the bearing tolerances. In the instance of pumps of the described kind, the gap width is expediently less than 0.1 preferably less than 0.05 mm. The size of the emergency bearing surfaces is defined through the axial extension of the gap. Said extension should not drop below 1.5 mm, in the case of oblique or stepped emergency bearing surfaces correspondingly larger.

It is of importance that in the instance of a failed bearing the friction produced by the emergency bearing surfaces 14, 15 is high so that the drive for the rotating system can switch to failure. The friction characteristic of the emergency bearing surfaces 14, 15 depends on the material (expediently hardened rolling bearing steel). By coating one or both emergency bearing surfaces (with MOS₂, Teflon, for example) it is not only possible to increase the amount of friction but also reduce the tendency of seizing for the given pair of materials.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

Having thus described the preferred embodiments, the invention is now claimed to be:

1.-18. (canceled)

19. A ball bearing, comprising:
an inner race and outer race serving as a mounting device and for guidance of a rotating machine component during normal operation;
an emergency bearing defined by:
emergency bearing surfaces disposed concentric relative to an axis of rotation, one of the concentric bearing surfaces being a component of a rotating bearing race and the other of the concentric bearing surfaces being a component of a stationary bearing race;
the emergency bearing surfaces being disposed opposite to each other during normal operation with a gap defined therebetween, such that in the event of failure of the ball bearing, the emergency bearing surfaces of the emergency bearing are configured to assume mounting and guidance functions of the failed ball bearing only during a one-time emergency rundown to a standstill of the rotating machine component;
a size of the gap being selected in such a manner that the emergency bearing surfaces positioned opposite each other are in contact with each other only during the emergency rundown, such that damage to the rotating machine component is avoided.

20. A machine including:
a stator;
a rotor supported on ball bearings;
a drive which drives the rotor;
a converter which, in response to an increase in driving power by a preselected amount, switches the drive to a failure mode;
at least one of the ball bearings being equipped with an emergency bearing, according to claim 19;
the emergency bearing surfaces being of a material such that friction generated during the emergency rundown increases the driving power by the preselected amount and the converter switches over to the failure mode.

21. The machine according to claim 20, wherein the emergency bearing surfaces are made of steel.

22. The machine according to claim 20, wherein the emergency bearing surfaces are made of tempered roller bearing steel.

23. The machine according to claim 20, wherein at least one of the two emergency bearing surfaces is coated.

24. The machine according to claim 20, wherein the machine is a friction vacuum pump.

25. The friction vacuum pump according to claim 24, further including:
a blocking gas device.

26. The bearing according to claim 19, wherein at least one of the emergency bearing surfaces are of a material which (1) increases an amount of friction, and (2) reduces a tendency of the bearing surfaces to seize.

27. The bearing according to claim 26, wherein at least one of the emergency bearing surfaces is coated.

28. The bearing according to claim 19, wherein the emergency bearing surfaces are configured such that in the event of the failure of the ball bearing, the emergency bearing surfaces form a friction bearing which (1) assumes the mounting and guidance functions of the failed ball bearing, (2) increases friction which is sufficient to trigger a failure mode in a drive which is driving the rotating machine component and bring the rotating machine component to a stop.

29. The bearing according to claim 28, wherein the emergency bearing surfaces are fabricated of steel.

30. The bearing according to claim 28, wherein the emergency bearing surfaces are fabricated of tempered roller bearing steel.

31. The bearing according to claim 19, wherein the gap between the emergency bearing surfaces is less than 0.1 mm.

32. The bearing according to claim 20, wherein the gap between the emergency bearing surfaces is less than 0.05 mm.

33. The bearing according to claim 19, further including:
a bearing cover defined by projections on which the emergency bearing surfaces are carried.

34. The bearing according to claim 19, wherein the concentric emergency bearing surfaces extend in an axial direction.

35. A machine with a stator and a rotor which is supported on rolling bearings including:
a drive for the rotor,
a converter for the drive, in case of an increase in driving power by a given amount, the convert switches the drive to “failure” mode;
wherein
at least one of the bearings includes the bearing according to claim 19;
a material of the emergency bearing surfaces being chosen in such a manner that the drive of the rotating system is unable to overcome friction generated between the emergency bearing surfaces during the “failure” mode.

36. The machine according to claim 35, wherein the machine is a friction vacuum pump.

37. A bearing comprising:
an inner race and an outer race serving a mounting and guidance functions for a rotating machine component during normal operation, the races having concentric surfaces relative to an axis of rotation, the surfaces being separated by a gap and positioned opposite and disengaged from each other during normal operation; wherein
the opposed surfaces function as an emergency bearing;
in the event of failure, the surfaces of the emergency bearing assume the mounting and guidance function during a one-time emergency rundown until standstill of the rotating machine component; and
a width of the gap is selected in such a manner that the opposed surfaces are in contact with each other during the emergency run, wherein damage to the rotating machine component is avoided.
